(19) United States
(12) Patent Application Publication
(10) Pub. No.: US 2014/0288671 A1
(43) Pub. Date: Sep. 25, 2014

(54) DATA COLLECTION SYSTEM, DATA COLLECTION APPARATUS, DATA COLLECTION SYSTEM PROGRAM, AND DATA COLLECTION PROGRAM

(71) Applicant: Akira Nojima, Minato-ku (JP)

(72) Inventor: Akira Nojima, Minato-ku (JP)

(73) Assignee: TOSHIBA MITSUBISHI-ELECTRIC INDUSTRIAL SYSTEMS CORPORATION, Minato-ku, Tokyo (JP)

(21) Appl. No.: 14/356,495

(22) PCT Filed: Jun. 26, 2012
(86) PCT No.: PCT/JP2012/066199

§ 371 Date: May 6, 2014

(51) Int. Cl. G05B 15/02

(52) U.S. Cl. CPC G05B 15/02
USPC 700/9

(57) ABSTRACT

The microprocessor core 414d is dedicated to perform the judgment processing to judge whether or not the sampling cycle has been reached on the basis of the time measured by the timer 411a; and if the microprocessor core 414d judges that the sampling cycle has been reached, the microprocessor cores 414a to 414c store the process data, which are stored in the first storage unit 411b, into the second storage unit 412.

### TECHNICAL FIELD

The present invention relates to a data collection system, a data collection apparatus, a data collection system program, and a data collection program for collecting data from control apparatuses which are widely used to control industrial systems such as: an FA sector including iron and steel plants, paper mill plants, and assembly operations in the automobile industry and the like; a PA sector including chemical plants; and water supply and sewage systems as well as other utility systems.

### BACKGROUND ART

Among generally-used control systems for controlling control objects such as plant equipment, there is a control system which is formed from multiple control apparatuses connected together via a network and controls the plant equipment by transferring control information among the control apparatuses via the network.

There is another control system which monitors the plant equipment by collecting data, such as process values, from the control apparatuses via the network.

There has been an idea that: a control system stores data on control of the plant equipment; and, for example, when an abnormal condition occurs in the plant equipment, the stored data are analyzed for use to examine causes of the occurrence of the abnormal condition, and to make plans about how to deal with the abnormal condition.

To this end, there has been a strong demand that multiple kinds of process values and the like of the stored data be displayed on the same display screen with the times of the stored data aligned with one another.

Patent Document 1 has proposed a data collection apparatus for an iron and steel plant system which is configured to: collect binary data of control information outputted from a control apparatus to an iron and steel plant; collect binary data of event information on the iron and steel plant controlled by use of the control information outputted from the control apparatus; add a common key to the binary data of the control information and the binary data of the event information which are collected at the same time; accumulate the binary data of the control information together with the attached common keys; and accumulate the binary data of the event information together with the attached common keys.

### PRIOR ART DOCUMENT

### Patent Document

Patent Document 1: Japanese Patent Application Publication No. 2010-271850

### SUMMARY OF INVENTION

### Problem to be Solved by Invention

Multiple control apparatuses configured to control iron and steel plants and paper mill plants each operate in one control cycle of several milliseconds. For this reason, in a case where data transmitted from the control apparatus described in Patent Document 1 are collected in a several-millisecond control cycle, the sampling time may shift ahead or behind by approximately several microseconds due to load or the like of calculation for the control.

As a result, the times of collecting data supplied from multiple control apparatuses are inaccurate and are not always exactly the same, and accordingly the process values collected at the same point of time are difficult to display adequately on the same display screen.

The present invention has been made with the foregoing problem taken into consideration. The present invention aims at providing a data collection system, a data collection apparatus, a data collection system program and a data collection program for collecting data at an appropriate sampling time with a simple configuration.

### Means for Solving the Problems

For the purpose of achieving the object, a first feature of a data collection system of the present invention is that the data collection system includes: multiple data collection apparatuses configured to collect data supplied from control apparatuses; and a data display apparatus connected to the multiple data collection apparatuses through a network and configured to display the data collected by the multiple data collection apparatus. Each of the multiple data collection apparatuses includes: a clock configured to measure a time; a storage unit configured to store, as process data, the data and the time measured by the clock in association with each other; and a microprocessor including multiple microprocessor cores. Any one of the microprocessor cores is dedicated to perform judgment processing to judge whether or not a sampling cycle has been reached on the basis of the time measured by the clock. If the microprocessor core judges that the sampling cycle has been reached, the other microprocessor cores store the process data into the storage unit. On the basis of the process data stored in the storage units in the multiple data collection apparatuses, the data display apparatus displays the multiple data on a display unit with their time axes aligned with each other.

A second feature of the data collection system of the present invention is that: one of the multiple data collection apparatuses is a master data collection apparatus which sends the time measured by its own clock to the other data collection apparatuses at predetermined intervals; and the other data collection apparatuses synchronize their own clocks with the time sent from the master data collection apparatus.

For the purpose of achieving the object, a first feature of a data collection apparatus of the present invention is that the data collection apparatus includes: a clock configured to measure a time; a storage unit configured to store, as process data, control target data and the time measured by the clock in association with each other; and a microprocessor including multiple microprocessor cores. Any one of the microprocessor cores is dedicated to perform judgment processing to judge whether or not a sampling cycle has been reached on the basis of the time measured by the clock. If the microprocessor core judges that the sampling cycle has been reached, the other microprocessor cores store the process data into the storage unit.

For the purpose of achieving the object, a first feature of a data collection system program of the present invention is that the data collection system program is executed by multiple data collection apparatuses configured to collect data supplied from control apparatuses, and by a data display apparatus connected to the multiple data collection apparatuses through a network and configured to display the data collected by the multiple data collection apparatuses. The data collection system program causes the multiple data collection apparatuses to execute: a storage step of storing, as process data, the data and a time measured by a clock into a storage unit in association with each other; and a storage controlling step of causing any one of multiple microprocessor cores to dedicatedly perform judgment processing to judge whether or not a sampling cycle has been reached on the basis of the time measured by the clock, and causing the other microprocessor cores to store the process data into the storage unit if the one microprocessor core judges that the sampling cycle has been reached, and causes the data display apparatus to execute a displaying step of displaying the multiple data on a display unit with their time axes aligned with each other on the basis of the process data stored in the storage unit in the multiple data collection apparatuses.

A second feature of the data collection system program is that the data collection system program further causes one of the multiple data collection apparatuses to function as a master data collection apparatus configured to send the time measured by its own clock to the other data collection apparatuses at predetermined intervals; and causes the other data collection apparatuses to execute a step of synchronizing their own clocks with the time sent from the master data collection apparatus.

For the purpose of achieving the object, a first feature of a data collection program of the present invention is that the data collection program causes a computer to execute: a storing step of storing, as process data, control target data and a time measured by a clock into a storage unit in association with each other; and a storage controlling step of causing any one of the multiple microprocessor cores to dedicatedly perform judgment processing to judge whether or not a sampling cycle has been reached on the basis of the time measured by the clock, and causing the other microprocessor cores to store the process data into the storage unit if the one microprocessor core judges that the sampling cycle has been reached.

### Effects of Invention

The data collection system, the data collection apparatus, the data collection system program and the data collection program of the present invention collect data at an appropriate sampling time with simple configurations.

### BRIEF DESCRIPTION OF DRAWINGS

FIG. 1 is a diagram showing connecting relationships in a data collection system of a first embodiment of the present invention.

FIG. 2 is a diagram schematically showing a concept of a scan transmission among common memories included, respectively, in control apparatuses and data collection apparatuses in the data collection system of the first embodiment of the present invention.

FIG. 3 is a diagram showing configurations of respective data collection apparatuses included in the data collection system of the first embodiment of the present invention.

FIG. 4 is a flowchart showing procedures of processing to be performed by another data collection apparatus included in the data collection system of the first embodiment of the present invention.

Referring to the drawings, descriptions will be hereinbelow provided for the best mode for carrying out the invention.

### First Embodiment

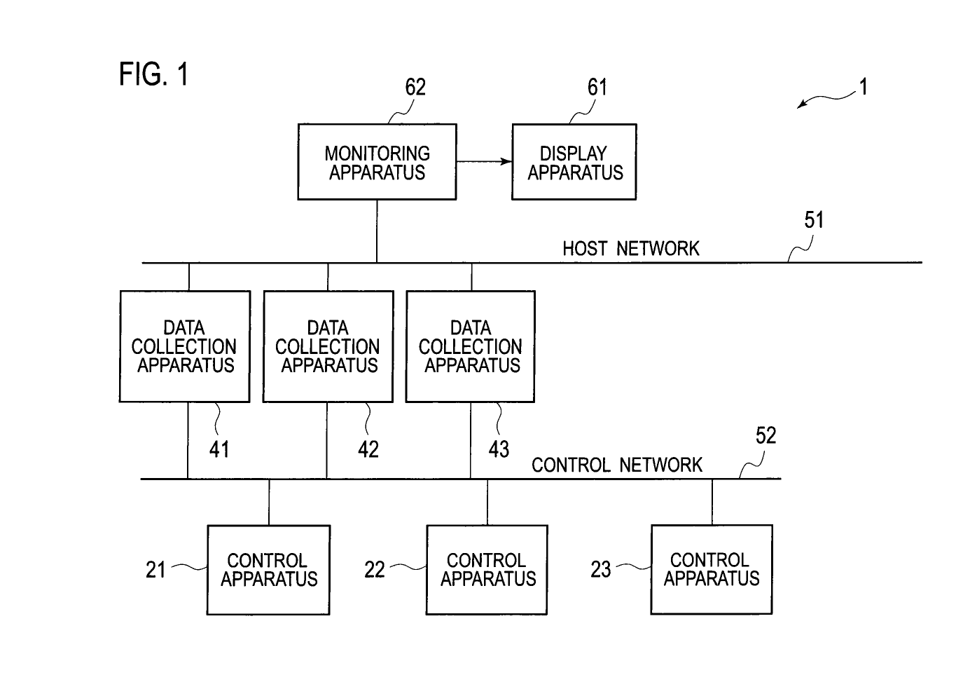

FIG. 1 is a diagram showing connecting relationships in a data collection system of a first embodiment of the present invention.

As shown in FIG. 1, a data collection system 1 of the first embodiment of the present invention includes control apparatuses 21, 22 and data collection apparatuses 41 to 43, which are connected together via a control network 52. The data collection system 1 further includes a monitoring apparatus 62, which is connected to the data collection apparatuses 41 to 43 via a host network 51.

Each of the control apparatuses 21, 22 is formed from a control controller whose typical example is a PLC (Programmable Logic Controller).

Each of the data collection apparatuses 41 to 43 is a computer apparatus configured to collect data supplied from the control apparatuses 21, 22. In this respect, when it comes down to controlling the plant equipment in a hot rolling plant, for instance, the term “data” means various types of data on plant control equipment needed to operate the hot rolling plant, and examples of the data include production instruction data, production result data, alarm data, roll data, model calculation data, model learning data, invariable data and parameter data.

Furthermore, the data collection apparatuses 41 to 43 and the control apparatuses 21, 22 connected to the control network include their respective common memories. The common memories collectively play a function as a network apparatus by scan transmission (cyclic transmission) which transmits control data among the apparatuses.

To this end, each common memory is provided with transmission data areas and reception data areas assigned to the apparatuses. Thereby, data in the transmission data area in the control apparatus 21, for example, are transferred to the common memories in all of the other apparatuses connected to the control network 52 by one round of data transmission. Descriptions will be provided later for the concept of the scan transmission among the common memories.

A display apparatus 61 includes an image output unit such as an organic EL (electroluminescence) display or a liquid crystal display, and is connected to the monitoring apparatus 62. The display apparatus 61 displays graphs and the like on the basis of output signals supplied from the monitoring apparatus 62.

The monitoring apparatus 62 causes the display apparatus 61 to display multiple data with their time axes aligned with each other on the basis of process data stored in the storage units of the data collection apparatuses 41 to 43. To put it specifically, the monitoring apparatus 62 causes the data acquired from the data collection apparatuses 41 to 43 to be displayed on a single trend graph on the display apparatus 61 with the times of the data aligned with one another.

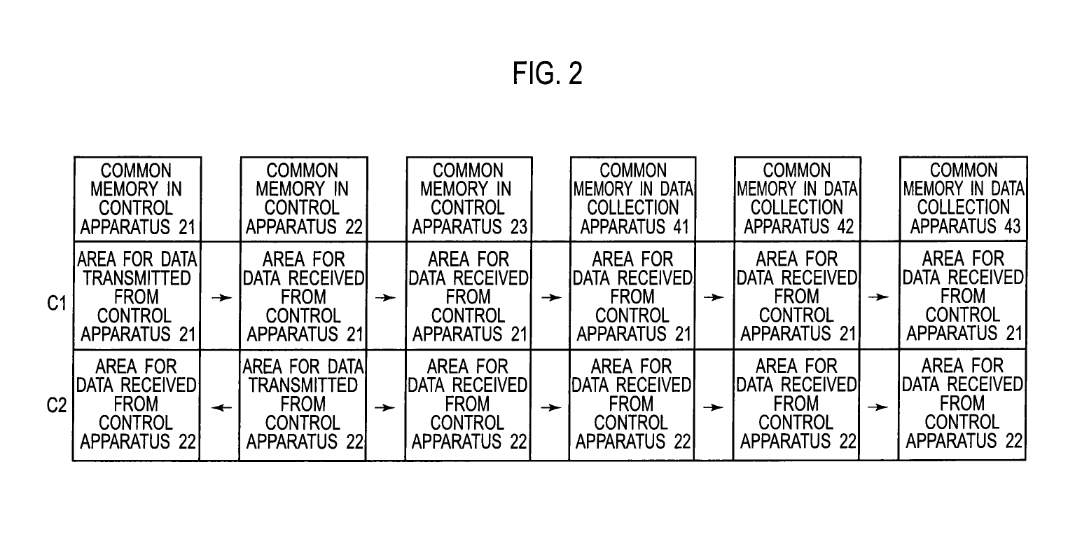

FIG. 2 is a diagram schematically showing the concept of the scan transmission among the common memories included, respectively, in the control apparatuses 21, 22 and the data collection apparatuses 41 to 43 in the data collection system 1 of the first embodiment of the present invention.

As shown in the line C1 in FIG. 2, for each control cycle, data in the transmission data area in the control apparatus 21 are transferred to the common memories in all of the other apparatuses (the control apparatuses 22, 23 and the data collection apparatuses 41 to 43) connected to the same transmission line in one round of the data transmission. As shown in the line C2, for each control cycle, data in a transmission data area in the control apparatus 22 are similarly transferred to the common memories in all of the other apparatuses (the control apparatuses 21, 23 and the data collection apparatuses 41 to 43).

As described above, each common memory is provided with the transmission data area assigned to the apparatus of its own, and the transmission data areas assigned respectively to the other apparatuses; and data are sent to the common memories in all of the other apparatuses by scan transmission. For this reason, all the apparatuses can share the same data.

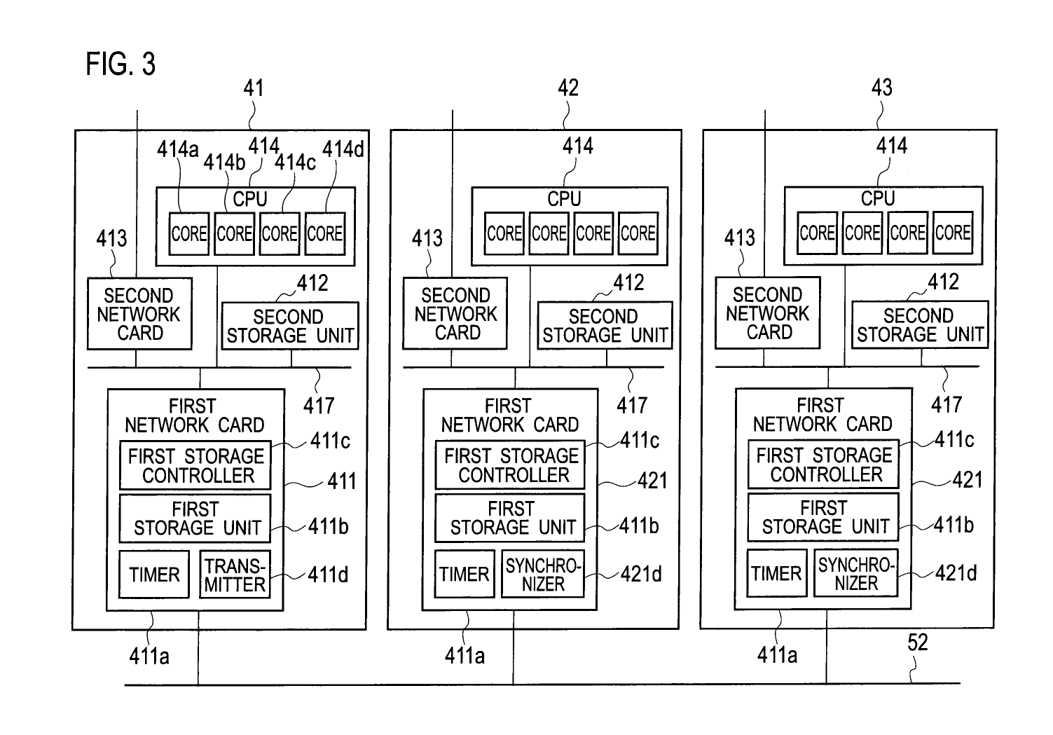

FIG. 3 is a diagram showing configurations of the respective data collection apparatuses 41 to 43 included in the data collection system 1 of the first embodiment of the present invention.

As shown in FIG. 3, the data collection system 1 includes the data collection apparatuses 41 to 43 connected together via the control network 52.

The data collection apparatus 41 (the master data collection apparatus) includes a first network card 411, a second storage unit 412, a second network card 413 and a CPU 414, which are connected together via a bus 417.

The first network card 411 is an interface card for connecting to the control network 52. The first network card 411 includes: a self-operating timer 411a for measuring time; a first storage unit 411b; a first storage controller 411c; and a transmitter 411d.

The first storage unit 411b is one of the above-described common memories, and stores data supplied from the control apparatuses 21, 22.

Once data in the transmission data area in the first storage unit 411b is rewritten with new data, the first storage controller 411c sends the new data to the other apparatuses by scan transmission. In addition, upon reception of new data by scan transmission, the first storage controller 411c rewrites old data in the reception data area in the first storage unit 411b.

The transmitter 411d multicasts the time measured by the timer 411a in the data collection apparatus 41, which is the apparatus of its own, on the control network 52 at predetermined intervals of, for example, 10 milliseconds.

The second storage unit 412 stores the time measured by the timer 411a and the data stored in the first storage unit 411b, as process data, while associating the time and the data with each other.

The second network card 413 is an interface card for connecting to the host network 51.

The CPU 414 centrally controls the data collection apparatus 41. In addition, the CPU 414 includes four microprocessor cores 414a to 414d.

Of the microprocessor cores 414a to 414d, the microprocessor core 414d performs only judgment processing to judge whether or not a sampling cycle has been reached on the basis of the time measured by the timer 411a. For example, the judgment processing is set to be assigned only to the microprocessor core 414d by use of an API (Application Program Interface) or the like equipped in an OS (Operating System). In this respect, the sampling cycle time is beforehand set at 1 millisecond, for example.

Thereby, the microprocessor core 414d performs nothing but the judgment process. For this reason, the microprocessor core 414d is capable of accurately judging whether or not the sampling cycle has been reached, even if process load on the CPU 414 becomes larger.

On the other hand, the microprocessor cores 414a to 414c store the process data, which are stored in the first storage unit 411b, into the second storage unit 412 if the microprocessor core 414d judges that the sampling cycle has been reached.

Like the data collection apparatus 41, the data collection apparatuses 42, 43 each include the second storage unit 412, the second network card 413 and the CPU 414, which are connected together through the bus 417.

Furthermore, the data collection apparatuses 42, 43 each include a first network card 421 instead of the first network card 411.

The first network card 421 is an interface card configured to connect to the control network 52. The first network card 421 includes: the self-operating timer 411a configured to measure a time; the first storage unit 411b; the first storage controller 411c; and a synchronizer 421d. Of these components, the timer 411a, the first storage unit 411b and the first storage controller 411c are the same as those included in the first network card 411 which are denoted by the same reference signs. For this reason, descriptions for the same components will be omitted.

On the basis of the time sent from the data collection apparatus 41 serving as the master data collection apparatus through the control network 52, the synchronizer 421d synchronizes the timer 411a included in the first network card 421 with the time thus sent.

This makes it possible to make the time of the timer 411a, included in each of the data collection apparatuses 42, 43, match the time of the timer 411a included in the data collection apparatus 41. Thereby, it is possible to provide the multiple data collection apparatuses on the control network 52, and to synchronize all the data collection apparatuses with one another.

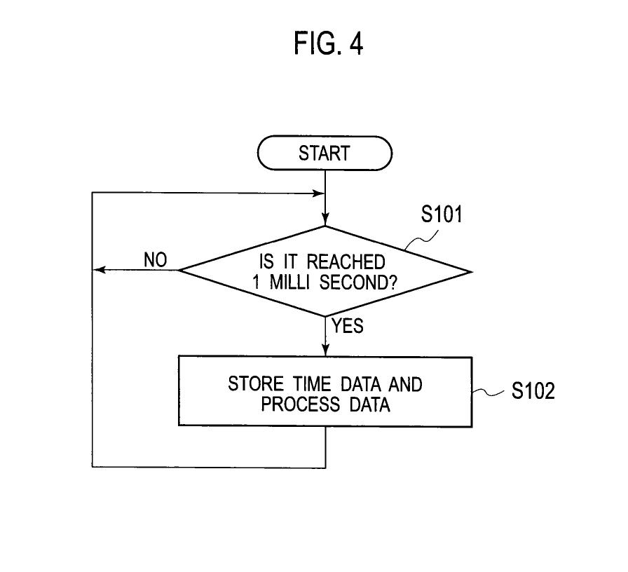

FIG. 4 is a flowchart showing procedures of processing to be performed by the data collection apparatuses 41 to 43 included in the data collection system 1 which is the first embodiment of the present invention.

As shown in FIG. 4, the microprocessor core 414d in the CPU 414 judges whether or not the sampling cycle (in this case, the sampling cycle time is at 1 millisecond) has been reached on the basis of the time measured by the timer 411a (step S101).

If the microprocessor core 414d judges in step S101 that the sampling cycle (in this case, the sampling cycle time is at 1 millisecond) has been reached (if YES), the microprocessor cores 414a to 414c store the process data, which are stored in the first storage unit 411b, into the second storage unit 412 (step S102).

Once the microprocessor cores 414a to 414c store the process data into the second storage unit 412, the microprocessor core 414d performs the processing of step S101.

As described above, the microprocessor core 414d in the CPU 414 judges whether or not the sampling cycle (in this case, the sampling cycle time is at 1 millisecond) has been reached on the basis of the time measured by the timer 411a. Since the microprocessor core 414d performs nothing but this judgment processing, the microprocessor core 414d uses all its resources for the judgment processing. Thereby, the microprocessor core 414d is capable of accurately judging whether or not the sampling cycle (in this case, the sampling cycle time is at 1 millisecond) has been reached.

As described above, in the data collection system 1 of the first embodiment of the present invention, the microprocessor core 414d is dedicated to perform the judgment processing to judge whether or not the sampling cycle has been reached on the basis of the time measured by the timer 411a; and if the microprocessor core 414d judges that the sampling cycle has been reached, the microprocessor cores 414a to 414c store the process data, which are stored in the first storage unit 411b, into the second storage unit 412. In this way, the data associated with the exact time can be collected as the process data. Thereby, on the basis of the collected process data, the monitoring apparatus 62 is capable of displaying the data acquired from the data collection apparatuses 41 to 43 on the single trend graph on the display unit 61 with the times of the data aligned with one another, and accordingly preventing time lags among the data.

This enables a user to review the data displayed on the trend graph on the display apparatus 61 in the comparative format, which have been acquired from the data collection apparatuses 41 to 43. For this reason, if some abnormal condition occurs in the plant, the user can review and analyze the stored trend graph for use to examine the cause of the occurrence of the abnormal condition and makes plans to deal with the abnormal condition. Furthermore, the user can use the stored process data to study how to improve the plant equipment for the purpose of enhancing the quality of products.

The first embodiment of the present invention has been described citing the data collection apparatus 41 in which if the microprocessor core 414d in the CPU 414 judges that the sampling cycle has been reached, the microprocessor cores 414a to 414c store the process data, which are stored in the first storage unit 411b, into the second storage unit 412. The present invention, however, is not limited to the first embodiment.

If the microprocessor core 414d in the CPU 414 judges that the sampling cycle has been reached, the microprocessor 414d, for example, may be configured to store the process data, which are stored in the first storage unit 411b, into the second storage unit 412.

Moreover, if the microprocessor core 414d in the CPU 414 judges that the sampling cycle has been reached, the microprocessor core 414d may inform the microprocessor cores 414a to 414c that one sampling cycle has been reached, and immediately thereafter resume performing the judgment processing to judge whether or not another sampling cycle has been reached. In this case, once the microprocessor cores 414a to 414c are informed by the microprocessor core 414d that the sampling cycle has been reached, the microprocessor cores 414a to 414c store the process data, which are stored in the first storage unit 411b, into the second storage unit 412 in parallel with the judgment processing by the microprocessor core 414d.

Thereby, the microprocessor core 414d only has to perform the minimum processing, and thus can collect the times with higher accuracy.

What is more, the foregoing embodiment may be realized by causing a computer to execute a data collection program installed therein. To put it specifically, the data collection apparatuses may be constructed in a way that: the data collection program is read from a storage medium in which the data collection program is stored in advance, and is executed by the CPU 414. Alternatively, the data collection apparatuses may be constructed in a way that the data collection program is transmitted via a communications network, installed, and executed by the CPU 414. Similarly, the data collection apparatuses 41 to 43 and the monitoring apparatus 62 may be constructed by executing a data collection system program.

### EXPLANATION OF REFERENCE SIGNS

data collection system
21 to 23 control apparatus
41 to 43 data collection apparatus
51 host network
52 control network
61 display apparatus
62 monitoring apparatus
411 first network card
411a timer
411b first storage unit
411c first storage controller
411d transmitter
412 second storage unit
413 second network card
414 CPU
414a to 414d microprocessor core
417 bus
421 first network card
421d synchronizer

### INDUSTRIAL APPLICABILITY

The present invention is applicable to a data collection system for collecting plant data, and the like.

1. A data collection system comprising multiple data collection apparatuses configured to collect data supplied from control apparatuses; and a data display apparatus connected to the multiple data collection apparatuses through a network and configured to display the data collected by the multiple data collection apparatus, wherein each of the multiple data collection apparatuses includes:
a clock configured to measure a time;
a storage unit configured to store, as process data, the data and the time measured by the clock in association with each other; and
a microprocessor including multiple microprocessor cores, any one of the microprocessor cores is dedicated to perform judgment processing to judge whether or not a sampling cycle has been reached on the basis of the time measured by the clock, if the microprocessor core judges that the sampling cycle has been reached, the other microprocessor cores store the process data into the storage unit,
wherein on the basis of the process data stored in the storage units in the multiple data collection apparatuses, the data display apparatus displays the multiple data on a display unit with their time axes aligned with each other.

2. The data collection system of claim 1, wherein
one of the multiple data collection apparatuses is a master data collection apparatus which sends the time measured by its own clock to the other data collection apparatuses at predetermined intervals; and
the other data collection apparatuses synchronize their own clocks with the time sent from the master data collection apparatus.

3. A data collection apparatus comprising:
a clock configured to measure a time;
a storage unit configured to store, as process data, control target data and the time measured by the clock in association with each other; and
a microprocessor including multiple microprocessor cores, any one of the microprocessor cores is dedicated to perform judgment processing to judge whether or not a sampling cycle has been reached on the basis of the time measured by the clock, if the microprocessor core judges that the sampling cycle has been reached, the other microprocessor cores store the process data into the storage unit.

4. A data collection system program is executed by multiple data collection apparatuses configured to collect data supplied from control apparatuses, and by a data display apparatus connected to the multiple data collection apparatuses through a network and configured to display the data collected by the multiple data collection apparatuses,
the data collection system program causing the multiple data collection apparatuses to execute:
a storage step of storing, as process data, the data and a time measured by a clock into a storage unit in association with each other; and
a storage controlling step of causing any one of multiple microprocessor cores to dedicatedly perform judgment processing to judge whether or not a sampling cycle has been reached on the basis of the time measured by the clock, and causing the other microprocessor cores to store the process data into the storage unit if the one microprocessor core judges that the sampling cycle has been reached, and
the data collection system program causing the data display apparatus to execute:
a displaying step of displaying the multiple data on a display unit with their time axes aligned with each other on the basis of the process data stored in the storage unit in the multiple data collection apparatuses.

5. The data collection system program of claim 4, wherein
the data collection system program causes one of the multiple data collection apparatuses to function as a master data collection apparatus configured to send the time measured by its own clock to the other data collection apparatuses at predetermined intervals; and
the data collection system program causes the other data collection apparatuses to execute a step of synchronizing their own clocks with the time sent from the master data collection apparatus.

6. A data collection program causing a computer to execute:
a storing step of storing, as process data, control target data and a time measured by a clock into a storage unit in association with each other; and
a storage controlling step of causing any one of the multiple microprocessor cores to dedicatedly perform judgment processing to judge whether or not a sampling cycle has been reached on the basis of the time measured by the clock, and causing the other microprocessor cores to store the process data into the storage unit if the one microprocessor core judges that the sampling cycle has been reached.
